(19) United States
(12) Patent Application Publication
(10) Pub. No.: US 2013/0339305 A1
(43) Pub. Date: Dec. 19, 2013

(54) METHODS OF BACKING UP AND RESTORING PROFILE, AND DEVICES THEREFOR

(71) Applicant: KT CORPORATION, Gyeonggi-do (KR)

(72) Inventors: Kwan Lae KIM, Seoul (KR); Chul Hyun PARK, Seoul (KR); Jin Hyoung LEE, Seoul (KR); Hyung Jin LEE, Seoul (KR)

(21) Appl. No.: 13/918,460

(22) Filed: Jun. 14, 2013

(30) Foreign Application Priority Data
Jun. 15, 2012 (KR) 10-2012-0064358
Jun. 5, 2013 (KR) 10-2013-0064930

(51) Int. Cl. G06F 17/30

(52) U.S. Cl. CPC G06F 17/30283
USPC 707/652

(57) ABSTRACT

Methods of backing up and restoring a profile and devices therefor are disclosed. The method of backing up a profile includes transmitting, by an authentication module, a profile backup command to an operator server, transmitting, by the operator server, information to the authentication module, the information being generated by confirming a state of at least one repository capable of storing the profile, and storing the profile in a selected repository. The method of restoring a profile includes transmitting, by an authentication module, a profile restoration command to an operator server, transmitting, by the operator server, information to the authentication module, the information being generated by confirming a state of at least one repository having a profile stored therein, and restoring, in an authentication module, a profile stored in a selected repository.

### CLAIM FOR PRIORITY

This application claims priority to Korean Patent Application Nos. 10-2012-0064358 filed on Jun. 15, 2012, 10-2013-0064930 filed on Jun. 5, 2013 in the Korean Intellectual Property Office (KIPO), the entire contents of which are hereby incorporated by reference.

### BACKGROUND

1. Technical Field

Example embodiments of the present invention relate to an eUICC (embedded Universal Integrated Circuit Card) environment, and more specifically, to technology for backing up and restoring a profile of an eUICC.

2. Related Art

A UICC (Universal Integrated Circuit Card) is a smart card that can be inserted into a terminal and used as a module for user authentication of a mobile communication network to which a user has subscribed. The UICC may store personal information (Short Message Service, phone book, etc.) of a user and operator information (International Mobile Subscriber Identity, Home Public Land Mobile Network, etc.) for a mobile network operator (hereinafter referred to as an operator or an MNO) to which the user has subscribed.

A UICC may also be called an SIM (Subscriber Identity Module) card when using a GSM (Global System for Mobile communications) scheme. The UICC may also be called a USIM (Universal Subscriber Identity Module) card when using a WCDMA (Wideband Code Division Multiple Access) scheme.

When a user mounts an UICC on a terminal of the user, user authentication is automatically performed using information stored in the UICC, enabling the user to conveniently use the terminal. Further, when the user replaces an existing terminal, the user can easily replace the terminal by mounting an UICC detached from the existing terminal on a new terminal.

Also, a terminal may be used by easily changing an MNO through replacement with an UICC of a desired MNO.

In other words, in a conventional UICC environment, an SIM profile prepared according to requirements of an MNO in advance is embedded in a separate card and distributed in the form separated from a terminal. A user purchases a terminal and an UICC in order to join in service of a specific MNO, inserts the UICC into the terminal, opens the terminal according to an opening procedure determined by the operator, and then uses the terminal.

It is difficult to miniaturize a terminal requiring miniaturization, such as a terminal for machine to machine (M2M) communication when the terminal is manufactured in a structure in which an UICC is capable of being attached or detached. Accordingly, an embedded UICC (eUICC) structure in which an UICC is incapable of being attached or detached has been proposed.

It is necessary to remotely update subscriber information of several mobile network operators in an eUICC due to introduction of the eUICC. Accordingly, a subscription manager (hereinafter referred to as an SM) for subscriber information management or a profile manager (hereinafter referred to as a PM) has been discussed.

Thus, the eUICC integrally mounted on a terminal is associated with many issues regarding opening right, additional service business leadership, subscriber information security and the like, due to its physical structure, unlike an existing detachable UICC. For this, international standardization organizations, such as GSMA and ETSI, are developing standardization activity for necessary elements including a top-level structure with affiliates such as an operator, a maker, or a SIM vendor. As the eUICC is discussed by standardization groups, an SM (subscription manager) is attracting attention. The SM refers to an entity or its function/role of serving to perform general management for the eUICC, including issuance of operator information (operator credential, profile, etc.) to an eSIM and a subscription changing process. Recently, a structure in which roles of the SM are classified into SM-DP (Data Preparation) of preparing a profile that can be safely subjected to provisioning in an eUICC, and SM-SR (Secure Routing) of performing a function of directly managing a profile in an eUICC, has been proposed by GSMA.

As the profile is issued in the eUICC in a software manner, the eUICC provides communication and additional services. In the case of the additional services, post-issuance (an individualization process, i.e., a process of actually issuing financing information) is performed in a service provider (a credit card company, a bank, securities, etc.) after the eUICC is issued, and an initially mounted profile is modified.

An eUICC integrally mounted on a terminal has a physical structure in which an eUICC is not detached, unlike an existing detachable UICC. This physical structure makes it difficult to replace a device through detachment of the eUICC. Accordingly, when a user replaces a device with another device supporting an eUICC, there is a need for a method of backing up an issued profile for which post-issuance of additional services has been completed, in an eUICC infrastructure (MNO, SM-DP, a service provider server, a maker server, a financial institution server, etc.), and restoring the profile in the new device supporting an eUICC. If there is no method of safely backing up and restoring the eUICC profile and the additional services have been post-issued in the device with an eUICC, all existing additional services must be reissued to a user when the device is replaced with a new device with an eUICC.

### SUMMARY

Accordingly, example embodiments of the present invention are provided to substantially obviate one or more problems due to limitations and disadvantages of the related art.

Example embodiments of the present invention provide methods of safely backing up, in a repository selected by a user, and restoring personal information of a user and operator information of a mobile network operator to which the user has subscribed, which are held in an eUICC device.

Example embodiments of the present invention also provide an eUICC device and an operator server capable of performing the above process in a backup or restoration process in an eUICC environment.

In some example embodiments, a method of backing up a profile includes: transmitting, by an eUICC device, a profile backup command to an operator server; transmitting, by the operator server, information for at least one repository capable of storing the profile to the eUICC device, the information being generated by confirming a state of the at least one repository; and storing the profile in a repository selected by the eUICC device based on the information for the at least one repository.

Here, the transmitting, by the eUICC device, of the profile backup command to the operator server may include transmitting credential information of a user of the eUICC device together with the profile backup command.

Here, the storing of the profile in the repository selected by the eUICC device based on the information for the at least one repository may include encoding the profile using an eUICC-specific key, and storing the encoded profile in the repository selected by the eUICC device.

Here, the storing of the profile in the repository selected by the eUICC device based on the information for the at least one repository may include storing the profile in two or more repositories selected by the eUICC device.

In other example embodiments, a method of restoring a profile includes transmitting, by an eUICC device, a profile restoration command to an operator server; transmitting, by the operator server, information for at least one repository having a profile stored therein to the eUICC device, the information being generated by confirming a state of the at least one repository; and restoring, in an eUICC, a profile stored in a repository selected by the eUICC device based on the information for the at least one repository.

Here, the transmitting, by the eUICC device, of the profile restoration command to the operator server may include transmitting credential information of a user of the eUICC device together with the profile restoration command.

Here, the restoring, in an eUICC, of the profile stored in the repository selected by the eUICC device based on the information for the at least one repository may include decoding the profile using an eUICC-specific key, and restoring the decoded profile in the eUICC.

In still other example embodiments, an eUICC device includes: an eUICC capable of storing a profile; a first transmission unit configured to transmit a profile restoration command to an operator server; a first reception unit configured to receive information for at least one repository from the operator server; and a first processing unit configured to restore, in an eUICC, a profile stored in a repository selected by the eUICC device according to the information for the at least one repository received by the first reception unit.

Here, the first transmission unit configured to transmit the profile restoration command to the operator server may transmit credential information of a user of the eUICC device together with the profile restoration command.

Here, the first processing unit decodes the profile using an eUICC-specific key, and restores the decoded profile in the eUICC.

Here, the first transmission unit may transmit a profile backup command to the operator server, and the first processing unit may store the profile of the eUICC device in the repository selected by the eUICC device according to the information for at least one repository received by the first reception unit.

Further, the first processing unit may encode the profile using an eUICC-specific key, and store the encoded profile in the repository selected by the eUICC device.

Further, the first processing unit may store the profile in two or more repositories selected by the eUICC device.

In still other example embodiments, an operator server includes: a second reception unit configured to receive a profile restoration command from an eUICC device; a second processing unit configured to confirm a state of at least one repository to generate information for the at least one repository according to the received restoration command; and a second transmission unit configured to transmit the information for the at least one repository generated by the second processing unit to the eUICC device.

Here, the second reception unit configured to receive the profile restoration command from the eUICC device may receive credential information of a user of the eUICC device together with the profile restoration command.

Here, the second reception unit may receive a profile backup command from the eUICC device, the second processing unit may confirm a state of at least one repository to generate information for the at least one repository according to the received backup command, and the second transmission unit may transmit the information for the at least one repository generated by the second processing unit to the eUICC device.

### Effects of the Invention

According to the method of backing up a profile according to the present invention as described above, the user can select a backup position of the profile. Further, there is an advantage that the profile can be safely stored by being encoded using the eUICC-specific key at the time of profile backup, and can be duplexed by being stored in a plurality of repositories.

Further, with the method of restoring a profile according to the present invention as described above, a profile backed up in various repositories can be selected and restored. There is an advantage that, when the profile is restored, the profile can be safely restored by being decoded using the eUICC-specific key and restored.

Further, with the eUICC device and the operator server according to the present invention as described above, there is an advantage that, when a user changes an eUICC device, an existing profile can be continuously used by restoring the profile backed up in advance without a process of newly installing the profile.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating methods for backup and restoration in an eUICC environment and their components according to an example embodiment of the present invention;

FIG. 2 is a flowchart illustrating a method of backing up a profile according to an example embodiment of the present invention;

FIG. 3 is an illustrative diagram illustrating a profile backup setting screen according to an example embodiment of the present invention;

FIG. 4 is an illustrative diagram illustrating a process of backing up a profile according to an example embodiment of the present invention;

FIG. 5 is a flowchart illustrating a method of restoring a profile according to an example embodiment of the present invention;

FIG. 6 is an illustrative diagram illustrating a profile restoration setting screen according to an example embodiment of the present invention;

FIG. 7 is an illustrative diagram illustrating a process of restoring a profile according to an example embodiment of the present invention;

FIG. 8 is a block diagram illustrating an eUICC device and its components according to an example embodiment of the present invention; and

FIG. 9 is a block diagram illustrating an operator server and its components according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

First, terms used in this application will be briefly described.

An operator as a term used in this application refers to a mobile network operator (MNO).

An SIM (Subscriber Identification Module) refers to a subscriber identification module and is an essential component of a GSM (Global System for Mobile communications) terminal. The SIM may be mainly implemented in the form of an IC card (Integrated Circuit Card). This card is a small card inserted into a slot that is usually provided in a rear portion of a terminal. An SIM profile means a specific set of information parameter values held in the SIM.

A profile as a term used in the present application refers to such an SIM profile.

Backup refers to a process of creating a copy of an original file in order to cope with an abnormal state, such as damage or loss of a file. A storage space for storing a file to copy is determined according to a size of the file. A data storage device includes any type of device, such as a magnetic medium or an optical medium. Backup may provide mobility, data security and the like, as well as a file copying function.

Restoration refers to a task of returning a state of a changed device or content of a storage device or a register, to an original one.

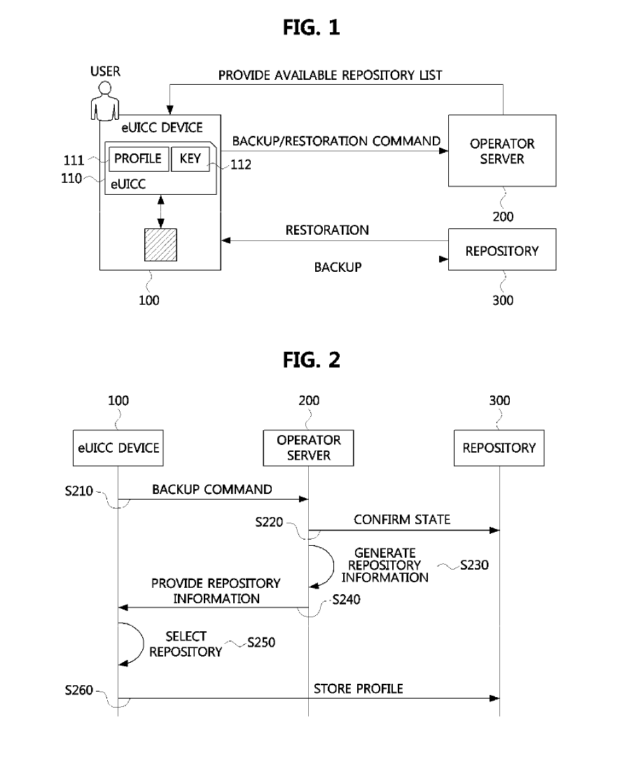

FIG. 1 is a conceptual diagram illustrating methods for backup and restoration in an eUICC environment and their components according to an example embodiment of the present invention. The components and the methods for backup and restoration in the eUICC environment will be briefly described with reference to FIG. 1.

In the eUICC environment of example embodiments of the present invention, the components may include a profile 111 having personal information of a user and subscriber information for the user stored therein, an eUICC 110 having this information 111 safely stored therein, a key uniquely issued to and stored in the eUICC 110, and an eUICC device 100 having the eUICC 110 embedded therein.

Further, other components may include an operator server 200 that manages subscribers, and a repository 300 in which the profile of the eUICC device 100 is to be backed up.

The repository that can be managed by the operator server 200 may include any type of storage device. The repository may be a storage embedded in the operator server 200, a repository in which a storage provided by a third party is connected via an API (Application Programming Interface) or the like, or a storage embedded in the eUICC device 100 requesting backup.

The methods for backup and restoration between the components will be briefly described. The eUICC device 100 transmits a backup or restoration command received from a user to the operator server 200, and the operator server 200 transmits repository information generated by confirming states of repositories 300 to the eUICC device 100. A backup or restoration task is performed between the eUICC device 100 and the repository selected by the eUICC device 100.

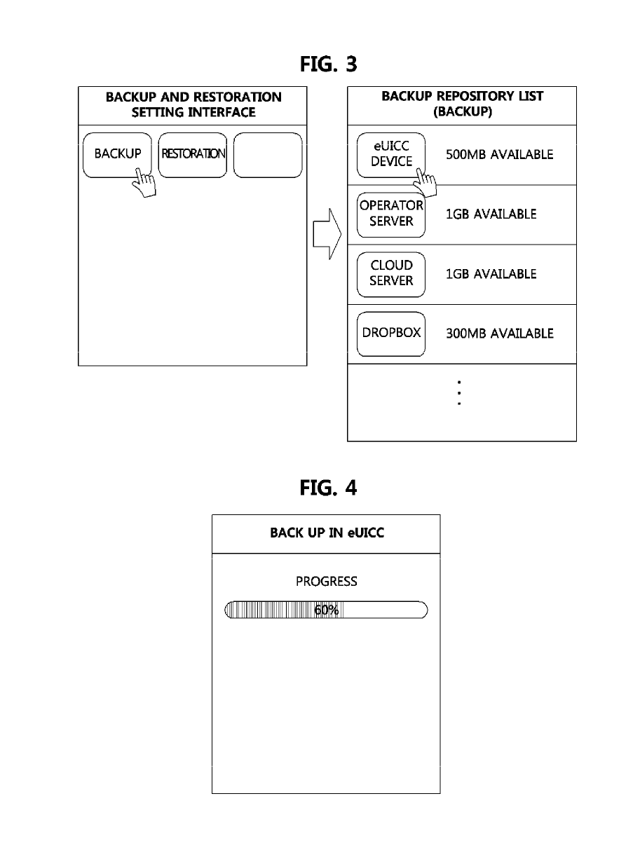

FIG. 2 is a flowchart illustrating a method of backing up a profile according to an example embodiment of the present invention, and FIG. 3 is an illustrative diagram illustrating a profile backup setting screen according to an example embodiment of the present invention. Further, FIG. 4 is an illustrative diagram illustrating a process of backing up a profile according to an example embodiment of the present invention. The method of backing up a profile in an eUICC environment will be described in detail with reference to FIGS. 2 to 4.

The method of backing up the profile of the eUICC device 100 may include a step (S210) in which the eUICC device 100 transmits a profile backup command to the operator server 200, a step (S240) in which the operator server 200 transmits, to the eUICC device 100, information for at least one repository 300 capable of storing the profile, which is generated (S230) by the operator server 200 confirming (S220) a state of the at least one repository 300, and a step (S260) of storing the profile in the repository 300 selected (S250) by the eUICC device 100 based on the information for the at least one repository 300.

The step (S210) in which the eUICC device 100 transmits the profile backup command to the operator server 200, may include transmitting credential information of a user of the eUICC device 100 together with the profile backup command. In this case, the credential information transmitted by the eUICC device 100 may be used for the operator server 200 to confirm whether a backup request is a fair backup request.

The step (S240) in which the operator server 200 transmits, to the eUICC device 100, information for at least one repository 300 capable of storing the profile, which is generated (S230) by the operator server 200 confirming (S220) a state of the at least one repository 300, may include transmitting the information for at least one repository 300 including a repository list having types, and a positional information list of the repositories 300.

The repository that can be managed by the operator server 200 may include any type of storage device. The repository may be a storage embedded in the operator server 200, a repository in which a storage provided by a third party is connected via an API (Application Programming Interface) or the like, or a storage embedded in the eUICC device 100 requesting backup.

After confirming current states of the repositories 300, the operator server 200 may create a repository list with additional information, such as available capacities of the repositories 300, and transmit the repository list to the eUICC device 100.

The step (S260) of storing the profile in the repository 300 selected (S250) by the eUICC device 100 based on the information for the at least one repository 300 may include encoding the profile using an eUICC-specific key 112, and storing the encoded profile in the repository 300 selected by the eUICC device 100. In this case, a key uniquely issued to and stored in the eUICC 110 may be used as the eUICC-specific key 112.

The eUICC device 100 may determine a backup place based on the information for the repository 300 including the repository list received from the operator server 200. Using an interface according to characteristics of the eUICC device 100, the repository may be selected using a device-specific method, such as screen touching or clicking.

Further, the step of storing the profile in the repository 300 selected by the eUICC device 100 based on the information for the at least one repository 300 may include storing the profile in two or more repositories selected by the eUICC device 100. The profile to be stored may be duplexed in order to increase reliability and safety of the profile. A method for duplexing may be utilized in a parallel manner or in a standby manner.

The repository in which the profile is duplexed and stored may be a storage embedded in the operator server 200, a repository in which a storage provided by a third party is connected via an API (Application Programming Interface) or the like, or a storage embedded in the eUICC device 100 requesting backup. For example, when the profile is stored in the repository, the profile may also be always sent to the operator server 200.

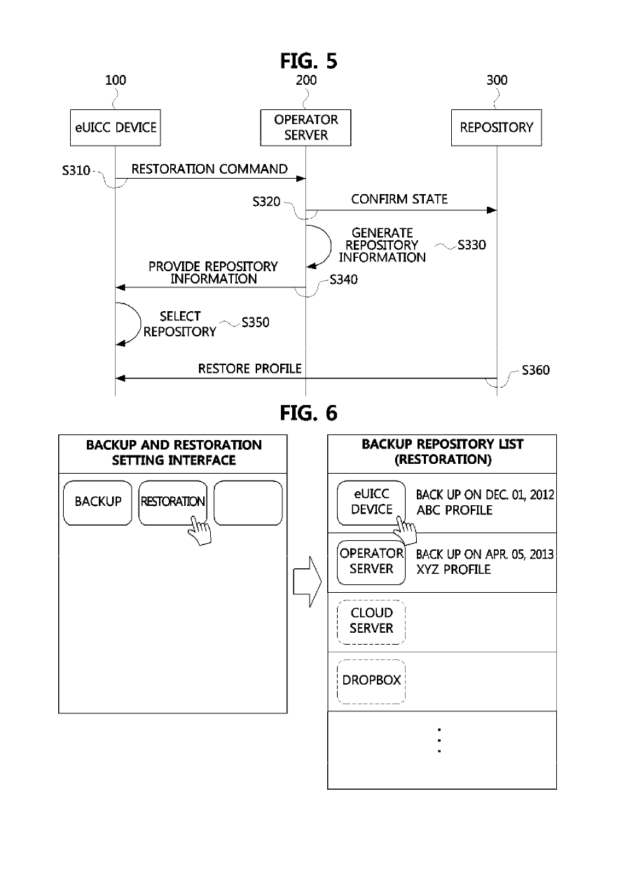

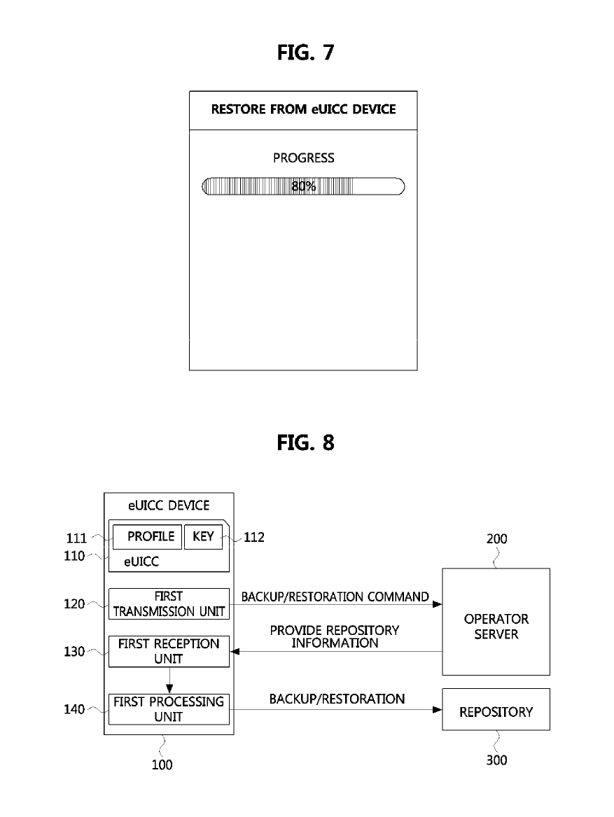

FIG. 5 is a flowchart illustrating a method of restoring a profile according to an example embodiment of the present invention, and FIG. 6 is an illustrative diagram illustrating a profile restoration setting screen according to an example embodiment of the present invention. Further, FIG. 7 is an illustrative diagram illustrating a process of restoring a profile according to an example embodiment of the present invention. The method of restoring a profile in an eUICC environment will be described in detail with reference to FIGS. 5 to 7.

The method of restoring the profile of the eUICC device 100 may include a step (S310) in which the eUICC device 100 transmits a profile restoration command to the operator server 200, a step (S340) in which the operator server 200 transmits, to the eUICC device 100, information for at least one repository 300 having the profile stored therein, which is generated (S330) by confirming (S320) a state of the at least one repository 300, and a step (S360) of restoring, in the eUICC 110, the profile stored in the repository 300 selected (S350) by the eUICC device 100 based on the information for the at least one repository 300.

The step (S310) in which the eUICC device 100 transmits the profile restoration command to the operator server 200, may include transmitting credential information of a user of the eUICC device 100 together with the profile restoration command. In this case, the credential information transmitted by the eUICC device 100 may be used for the operator server 200 to confirm whether a restoration request is a fair restoration request.

The step (S340) in which the operator server 200 transmits, to the eUICC device 100, information for at least one repository 300 having the profile stored therein, which is generated (S330) by confirming (S320) a state of the at least one repository 300, may include information for at least one repository 300 including a repository list having a list of types of repositories, positional information, stored profiles, storage date and time, etc.

As the repository managed by the operator server 200, the repository having a restoration target profile stored therein may be any type of storage device. The repository may be a storage embedded in the operator server 200, a repository in which a storage provided by a third party is connected via an API or the like, or a storage embedded in the eUICC device 100 requesting restoration.

After confirming current states of the repositories 300, the operator server 200 may create a repository list with additional information, such as storage date and time of the profile stored in the repository 300, and transmit the repository list to the eUICC device 100 requesting the restoration.

The step (S360) of restoring the profile stored in the repository 300 selected (S350) by the eUICC device 100 based on the information for the at least one repository 300 may include decoding the profile using an eUICC-specific key 112, and restoring the decoded profile in the eUICC 110. In this case, a key uniquely issued to and stored in the eUICC 110 may be used as the eUICC-specific key 112.

The eUICC device 100 may determine the repository 300 storing the profile to be first restored, based on the information for the repository 300 including the repository list received from the operator server 200. Using an interface according to characteristics of the eUICC device 100, the repository 300 may be selected using a device-specific method, such as screen touching or clicking.

When the profile has been duplexed and stored in order to increase reliability and safety of the profile, the profile can be restored more safely and reliably.

For example, when the profile has been duplexed in a parallel manner, the eUICC device 100 may selectively restore profiles having the same content stored in two or more repositories. When the restoration from one repository fails, the eUICC device 100 may immediately select the other repository to perform a restoration task.

On the other hand, when the profile has been duplexed in a standby manner, the eUICC device 100 may perform a restoration task from one master repository. When this task fails, the eUICC device 100 may automatically immediately perform the restoration task from the other servant repository. For example, the operator server 200 may be a place suitable to be utilized as the servant repository.

FIG. 8 is a block diagram illustrating the eUICC device 100 and its components according to an example embodiment of the present invention. The eUICC device 100 and the components will be described in detail with reference to FIG. 8.

The eUICC device 100 may include an eUICC 110 capable of storing a profile, a first transmission unit 120 that transmits a profile restoration command to an operator server 200, a first reception unit 130 that receives information for at least one repository 300 from the operator server 200, and a first processing unit 140 that restores, in the eUICC 110, a profile stored in a repository selected by the eUICC device 100 according to the information for at least one repository 300 received by the first reception unit 130.

The eUICC 110 capable of storing the profile may include a profile 111 having personal information of a user and subscriber information for the user stored therein, and a key uniquely issued to and safely stored in the eUICC 110.

The first transmission unit 120 transmitting the profile restoration command to the operator server 200 may transmit credential information of a user of the eUICC device 100 together with the profile restoration command. In this case, the credential information transmitted by the first transmission unit 120 may be used for the operator server 200 to confirm whether a restoration request is a fair restoration request.

The first reception unit 130 receiving the information for at least one repository 300 from the operator server 200 may receive the information for the repository 300 including a repository list having a list of types of repositories, positional information, stored profiles, storage date and time, etc. in a restoration step.

The first processing unit 140 may decode the profile using the eUICC-specific key 112, and restore the decoded profile in the eUICC 110 in the restoration step. In this case, a key uniquely issued to and stored in the eUICC 110 may be used as the eUICC-specific key 112.

Meanwhile, in a backup step, the first transmission unit 120 transmits a profile backup command to the operator server 200, and the first processing unit 140 may store the profile, which has been stored in the eUICC 110, in the repository selected by the eUICC device 100 according to the information for at least one repository 300 received by the first reception unit 130.

The first transmission unit 120 transmitting the profile backup command to the operator server 200 may transmit credential information of a user of the eUICC device 100 together with the profile backup command. In this case, the credential information transmitted by the first transmission unit 120 may be used for the operator server 200 to confirm whether a backup request is a fair backup request.

The first reception unit 130 receiving the information for at least one repository 300 from the operator server 200 may receive the information for the repository including a repository list having a list of types of repositories and positional information in a backup step.

The first processing unit 140 may encode the profile 111 using an eUICC-specific key 112, and store the encoded profile in the repository selected by the eUICC device 100. In this case, a key uniquely issued to and stored in the eUICC 110 may be used as the eUICC-specific key 112.

Further, the first processing unit 140 may store the profile in two or more repositories selected by the eUICC device 100.

The repository may include any type of storage device. The repository may be a storage embedded in the operator server 200, a repository in which a storage provided by a third party is connected via an API or the like, or a storage embedded in the eUICC device 100 having requested the backup.

Storing the profile in the two or more repositories is intended to increase reliability and safety of the profile to be stored. Duplexing for this may be utilized in a parallel manner or in a standby manner.

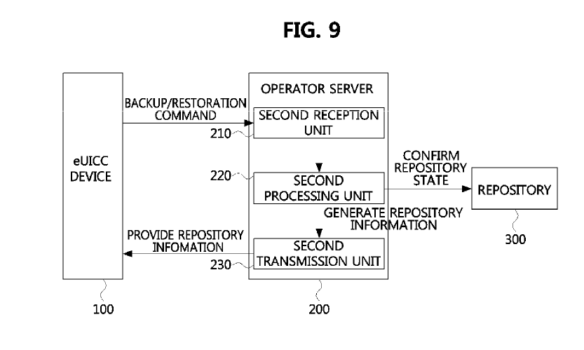

FIG. 9 is a block diagram illustrating the operator server 200 and its components according to an example embodiment of the present invention. The operator server 200 and the components will be described in detail with reference to FIG. 9.

The operator server 200 may include a second reception unit 210 that receives a profile restoration command from an eUICC device 100, a second processing unit 220 that generates information for at least one repository by confirming a state of the at least one repository according to the received restoration command, and a second transmission unit 230 that transmits the information for at least one repository generated by the second processing unit 220 to the eUICC device 100.

The second reception unit 210 receiving the profile restoration command from the eUICC device 100 may receive the credential information of a user of the eUICC device 100 together with the profile restoration command. In this case, the credential information received by the second reception unit 210 may be used for the operator server 200 to confirm whether a restoration request is a fair restoration request.

The second processing unit 220 generating information for at least one repository by confirming the state of the at least one repository according to the received restoration command may confirm current states of the repositories, and then create a repository list with additional information, such as storage date and time of profiles stored in the repositories.

As the repository managed by the operator server 200, the repository having a restoration target profile stored therein may be any type of storage device. The repository may be a storage embedded in the operator server 200, a repository in which a storage provided by a third party is connected via an API or the like, or a storage embedded in the eUICC device 100 requesting the restoration.

The second transmission unit 230 may transmit the information for at least one repository generated by the second processing unit 220 to the eUICC device 100. The second transmission unit 230 may transmit the information for the repository including a repository list with the additional information, such as storage date and time of profiles, to the eUICC device requesting the restoration.

Meanwhile, in a backup step, the second reception unit 210 may receive a profile backup command from the eUICC device 100, the second processing unit 220 may confirm a state of at least one repository to generate information for the at least one repository according to the received backup command, and the second transmission unit 230 may transmit the information for the at least one repository generated by the second processing unit 220 to the eUICC device 100.

The second reception unit 210 that may receive the profile backup command from the eUICC device 100, may receive credential information of a user of the eUICC device 100 together with the profile backup command. In this case, the credential information received by the second reception unit 210 may be used for the operator server 200 to confirm whether a backup request is a fair backup request.

The second processing unit 220 that may confirm a state of at least one repository to generate information for the at least one repository according to the received backup command, may generate the information of the repository including a repository list having types, and a positional information list of repositories.

The second transmission unit 230 that may transmit the information for the at least one repository generated by the second processing unit 220 to the eUICC device 100, may transmit the information for the repository including the repository list together with the additional information, such as available capacities of repositories, generated by the second processing unit 220, to the eUICC device 100 requesting the backup.

While the example embodiments of the present invention and their advantages have been described in detail, it should be understood that various changes, substitutions and alterations may be made herein without departing from the scope of the invention.

[List of Reference numerals]

| | |
|---|---|
| 100: eUICC device | 110: eUICC |
| 111: profile | 112: unique key |
| 120: first transmission unit | 130: first reception unit |
| 140: first processing unit | 200: operator server |
| 210: second reception unit | 220: second processing unit |
| 230: second transmission unit | 300: repository |

What is claimed is:

1. A method of backing up a profile of an eUICC device, the method comprising:
transmitting, by the eUICC device, a profile backup command to an operator server;
transmitting, by the operator server, information for at least one repository capable of storing the profile to the eUICC device, the information being generated by confirming a state of the at least one repository; and
storing the profile in a repository selected by the eUICC device based on the information for the at least one repository.

2. The method according to claim 1, wherein the transmitting, by the eUICC device, of the profile backup command to the operator server includes transmitting credential information of a user of the eUICC device together with the profile backup command.

3. The method according to claim 1, wherein the storing of the profile in the repository selected by the eUICC device based on the information for the at least one repository includes encoding the profile using an eUICC-specific key and storing the encoded profile in the repository selected by the eUICC device.

4. The method according to claim 1, wherein the storing of the profile in the repository selected by the eUICC device based on the information for the at least one repository includes storing the profile in two or more repositories selected by the eUICC device.

5. A method of restoring a profile in an eUICC device, the method comprising:
transmitting, by the eUICC device, a profile restoration command to an operator server;
transmitting, by the operator server, information for at least one repository having a profile stored therein to the eUICC device, the information being generated by confirming a state of the at least one repository; and
restoring, in an eUICC, a profile stored in a repository selected by the eUICC device based on the information for the at least one repository.

6. The method according to claim 5, wherein the transmitting, by the eUICC device, of the profile restoration command to the operator server includes transmitting credential information of a user of the eUICC device together with the profile restoration command.

7. The method according to claim 5, wherein the restoring, in an eUICC, of the profile stored in the repository selected by the eUICC device based on the information for the at least one repository includes decoding the profile using an eUICC-specific key and restoring the decoded profile in the eUICC.

8. An eUICC device comprising:
an eUICC capable of storing a profile;
a first transmission unit configured to transmit a profile restoration command to an operator server;
a first reception unit configured to receive information for at least one repository from the operator server; and
a first processing unit configured to restore, in an eUICC, a profile stored in a repository selected by the eUICC device according to the information for the at least one repository received by the first reception unit.

9. The eUICC device according to claim 8, wherein the first transmission unit configured to transmit the profile restoration command to the operator server transmits credential information of a user of the eUICC device together with the profile restoration command.

10. The eUICC device according to claim 8, wherein the first processing unit decodes the profile using an eUICC-specific key, and restores the decoded profile in the eUICC.

11. The eUICC device according to claim 8, wherein:
the first transmission unit transmits a profile backup command to the operator server, and
the first processing unit stores the profile of the eUICC device in the repository selected by the eUICC device according to the information for at least one repository received by the first reception unit.

12. The eUICC device according to claim 11, wherein the first processing unit encodes the profile using an eUICC-specific key, and stores the encoded profile in the repository selected by the eUICC device.

13. The eUICC device according to claim 11, wherein the first processing unit stores the profile in two or more repositories selected by the eUICC device.

14. An operator server comprising:
a second reception unit configured to receive a profile restoration command from an eUICC device;
a second processing unit configured to confirm a state of at least one repository to generate information for the at least one repository according to the received restoration command; and
a second transmission unit configured to transmit the information for the at least one repository generated by the second processing unit to the eUICC device.

15. The operator server according to claim 14, wherein the second reception unit configured to receive the profile restoration command from the eUICC device receives credential information of a user of the eUICC device together with the profile restoration command.

16. The operator server according to claim 14, wherein:
the second reception unit receives a profile backup command from the eUICC device,
the second processing unit confirms a state of at least one repository to generate information for the at least one repository according to the received backup command, and
the second transmission unit is capable of transmitting the information for the at least one repository generated by the second processing unit to the eUICC device.
